(19) United States
(12) Patent Application Publication
(10) Pub. No.: US 2008/0047970 A1
(43) Pub. Date: Feb. 28, 2008

(54) COVERSLIP DISPENSING DEVICE

(75) Inventors: Ian KERROD, Flintshire (GB); Christopher Leighton, Elton (GB); Caroline Breen, Chester (GB)

Correspondence Address: STITES & HARBISON PLLC, 1199 NORTH FAIRFAX STREET, SUITE 900, ALEXANDRIA, VA, 22314, US

(73) Assignee: THERMO SHANDON LTD., Cheshire (GB)

(21) Appl. No.: 11/835,058

(22) Filed: Aug. 7, 2007

(30) Foreign Application Priority Data
Aug. 25, 2006 (GB) 0616900.7

(51) Int. Cl. G01N 1/31

(52) U.S. Cl. 221/13

(57) ABSTRACT

A portable battery operated coverslip dispensing device 50 includes an optical sensor 64. The optical sensor detects proximity, for example the proximity of a user's hand. The optical sensor is associated with a switch that operates the dispensing mechanism 8 in response to a signal from the optical sensor. When that signal has been received, the dispensing mechanism 8 moves the blade 10 through one cycle, i.e. the blade is moved from a start position (as shown in FIG. 1) to an extended position (at which point a coverslip has been moved to the dispensed position 60) and back to the start position. The dispense mechanism then stops. In order to dispense another coverslip the user must activate the optical sensor again.

The present invention is concerned with coverslip dispensing devices, in particular portable devices for delivering a single coverslip on demand. Embodiments of the present invention are concerned with coverslip dispensing devices for delivering pre-coated coverslips.

Portable coverslip dispensing devices typically provide only a single coverslip at a time and the user must then remove the dispensed coverslip and apply it to a slide manually. Such devices are therefore much smaller than fully automated Coverslippers that not only dispense coverslips but also automate the application of the coverslip to a slide. Portable devices are a useful alternative to fully automated Coverslippers in situations where only a small number of slides are to be processed or where different preparation steps (e.g. different mountant) are required for each sample. The dispensing mechanism used in a portable coverslip device needs to be small so that the overall size of the portable device is kept to a minimum. Since such devices must also be affordable (and substantially cheaper than the fully automated machines) the dispensing mechanism may also be limited in terms of its complexity. Thus, a different approach to the design of portable devices is required, compared to the fully automated machines.

Also, in a portable device the coverslip can be dispensed onto a coverslip support structure that is fixed to the device, whereas in fully automated Coverslippers the coverslip is typically dispensed onto a transfer structure that moves with respect to the rest of the Coverslipper.

Unlike fully automated Coverslipper machines, portable devices are typically battery operated.

For ease of subsequent description the following definitions and explanations will use apparently absolute orientations such as “up”, “down”, “front”, “rear”, “top” and “bottom” and analogous terms, for example with reference to an embodiment in which the coverslip is dispensed with a dry film on its upper face or with reference to the direction in which a coverslip is dispensed (i.e. in a forward direction). However, the descriptions concerned will apply equally to embodiments in other absolute orientations unless the context clearly requires otherwise.

Known portable coverslip dispensing devices are typically switch operated so that a user depresses a switch when they want to dispense a coverslip. The present inventors have found that this requirement can cause solvent contamination due to the need for the user to make physical contact with the device. It is often the case that a user's hands will come into contact with solvent or even samples that are to be mounted on a slide. It is impractical for the user to change or wash their gloves each time they want to mount a coverslip on a slide and therefore there is always the risk that solvent or other contaminant can be deposited on the switch. This can then be transferred to the next coverslip that the user (or a subsequent user) picks up from the machine.

It is also known for portable coverslip dispensing devices to include a switch that is activated when a coverslip is removed from the device, thereby triggering dispensing of a further coverslip as soon as the previous one is removed. This has the disadvantage that a coverslip will always be present in a dispensed position, whether an additional coverslip is needed or not. This can lead to contamination or damage of the coverslip if it remains exposed for extended periods.

To address these drawbacks, the present inventors propose that a coverslip dispensing device should be operable without the need to depress a switch or make physical contact with the device, and suitably to make dispensing of a coverslip “on demand”, rather than obligatory, after removal of a coverslip.

In a first aspect the present invention provides a coverslip dispensing device having a non-contact sensor associated with a coverslip dispensing mechanism wherein activation of the sensor causes operation of the dispensing mechanism.

Preferably with this arrangement a user can cause a coverslip to be dispensed by e.g. passing a hand over the non-contact sensor. In preferred arrangements this causes a response in the sensor which in turn causes the dispensing mechanism to operate and dispense a coverslip.

This arrangement avoids the need for the user to touch the device each time they require a coverslip. It also ensures that a coverslip is dispensed only when it is needed.

Suitably activation of the sensor means is caused by a change or transition in the condition detected by the sensor. Typically this results in a change in sensor output. For example, a user could bring their hand towards the sensor, which would cause the sensor to detect movement or a change in proximity. Indeed, it is preferred that the non-contact sensors detects at least one of motion and proximity. Switching this results in a change in sensor output, e.g. from “0” to “1”, or vice versa. The change or transition in the detected condition preferably only needs to be temporary.

Preferably the non-contact sensor is an optical sensor. Alternatively it could be a capacitative sensor. Suitably the non-contact sensor detects motion and/or proximity, e.g. of a user's hand.

Suitably the non-contact sensor is located on the exterior of the device, e.g. on the outer casing of the device. Suitably it faces towards the front of the device, i.e. in the direction in which coverslips are dispensed. Preferably it is located on a forward-facing part of the outer casing. This means that the sensor is easily accessible.

Typically the non-contact sensor is associated with dispense activation means, such as an electrical switch, that causes the dispensing mechanism to operate. Thus, in preferred embodiments activation of the sensor causes an electrical switch to activate, thereby operating the dispensing mechanism. In preferred arrangements the non-contact sensor is associated with a control system that initiates dispensing of a coverslip in response to a signal or change in signal from the sensor.

Suitably no input or signal to the device other than activation of the non-contact sensor is required in order to dispense a coverslip. Typically activation or triggering of the sensor causes the dispensing mechanism to dispense one coverslip and then stop. In preferred embodiments, in response to a signal from the sensor, the dispensing mechanism (e.g. including a dispense blade as discussed below) moves from a start position to a dispensed position and then back to the start position, at which point the dispensing mechanism stops.

Suitably, the device is adapted to operate so that separate user activation of the sensor is required for each coverslip that is dispensed.

Typically coverslips are stored in a stack (usually in a cartridge) and the coverslip dispensing device dispenses the coverslip from the bottom of the stack. Alternatively, the coverslips can be dispensed from the top of the stack.

Preferably the device is portable. As used herein, the term “portable” means having one or more of the properties discussed herein that are characteristic of a portable coverslip device (c.f. a fully automated Coverslipper as discussed above). Thus, preferably the term “portable” means one or more of the properties discussed in the following section.

Suitably the device is battery operated. Preferably it includes means for connecting a battery to the device. Suitably the device includes a battery.

Preferably the device is portable in the sense that it can be readily carried by a user, preferably in one hand. This means that the device can be moved easily, e.g. between laboratories or preparation areas. Suitably the device does not include means for automatically bringing a coverslip and a glass slide together (i.e. there is no mechanism of the sort found in a fully automated Coverslipper).

Typically the largest dimension of the device is less than 30 cm, more preferably less than 20 cm. Suitably it weighs no more than 4 kg, preferably less than 2 kg.

Preferably the device includes coverslip cartridge retaining means that locate a coverslip cartridge with respect to the device during use. For example, this could be a suitably sized aperture or recess provided in the device casing or in a cartridge housing. Suitably the cartridge retaining means includes cartridge fixing means for fixing the cartridge with respect to the device. Suitably the fixing means includes a resilient member such as a spring, for holding the cartridge in place. These are further properties that can be characteristic of a portable coverslip device.

Suitably the device includes a cartridge for holding coverslips. Suitably, the coverslip can be stored as a stack in the cartridge. Preferably the cartridge is fixed to the device during operation of the device.

Preferably the device includes an outer casing. Suitably the device is adapted so that when a coverslip is dispensed into a dispensed position it is located externally to the outer casing. Preferably a coverslip cartridge, when located on the device, extends outside the outer casing. Again, these can be characteristics of a portable device.

Known portable coverslip dispensers comprise a roller system for delivering the coverslip or glass sheet from a stack of coverslips. The roller system acts on the underside of the bottommost coverslip in the stack. The mechanism relies on frictional forces between the underside of the coverslip and the roller surface. A drawback of this arrangement is that delivery of coverslips can be unreliable because of insufficient grip between the coverslip and rollers and/or because of adhesion between adjacent coverslips.

Whilst suggestions have been made for addressing this problem, for example by providing the rollers with a polygonal cross section to induce vibrations in the coverslips, there still remains a problem in providing reliable and smooth delivery of coverslips. Furthermore, the present inventors have found that the use of rollers of any shape can have a detrimental affect on the surface of the coverslip that is contacted by the rollers. Rollers, particularly non-circular ones, can create localised pressure points that can damage the surface of the coverslip.

At its most general, a further proposal of the present inventors is that the above drawbacks can be addressed by providing a dispensing mechanism that does not contact the top or bottom face of the coverslip but instead imparts a force to the coverslip by contacting only a circumferential (edge) face of the coverslip as it moves the coverslip towards the front of the device.

Preferably the coverslip device of the present invention includes a dispensing mechanism for transferring a coverslip from a start position to a dispensed position, the coverslip having top and bottom faces and circumferential faces connecting the top and bottom faces, wherein the dispensing mechanism contacts only a circumferential face of the coverslip during dispensing of the coverslip.

Thus, contact with the top and bottom faces is avoided. Typically the dispensing mechanism contacts the rear circumferential face of the coverslip (i.e. the rear end face of the coverslip). Preferably the dispensing mechanism is located rearwardly with respect to a coverslip in the start position. For example, the dispensing mechanism can be located behind the cartridge retaining means discussed above. Of course, in the case where the dispensing mechanism includes a dispense blade (see below), the dispense blade will in use extend in a forward direction to dispense the blade.

Preferably the dispensing mechanism is located below the coverslip in the start position, for example in the base of the device.

Preferably the dispensing mechanism includes a dispense blade. Suitably in use the blade contacts the rear circumferential face of a coverslip. Alternatively, a carriage system can be used to dispense the coverslips.

Suitably the dispense blade has a linear dispensing motion, preferably in a horizontal direction. Thus, suitably the blade provides a horizontal displacement force to a coverslip in use.

Preferably the dispense blade has a thickness that is less than the thickness of the coverslip that it is desired to transfer. Coverslips are available in a range of sizes, most commonly with a thickness of about 0.17 mm. The blade thickness is therefore preferably selected to be smaller than the thinnest coverslip that is to be used. Preferably the blade thickness is less than 0.17 mm, preferably 0.14 mm or less, more preferably 0.13 mm or less and most preferably 0.1 mm or less.

Preferably the dispense blade is narrower than the width of the coverslip that is to be dispensed. Typically, the blade has a width in the range 10 to 15 mm, more preferably 11 to 14 mm.

Suitably the end profile of the dispense blade (i.e. the profile of the end of the blade that contacts the coverslip) is square (i.e. the end circumferential face of the blade is substantially at right angles to the upper and lower blade faces). A sharper, squarer end profile can help to reduce the incidence of coverslips “jumping out”.

Preferably the blade can be changed by the user. Suitably the device includes blade retaining means that can be adjusted between a first position wherein the blade is fixed to the device and a second position wherein the blade can be removed from the device.

Suitably the dispense blade is connected to a dispense blade actuator that moves the dispense blade against the coverslip, typically on activation of the device by the user. Preferably the dispense blade actuator is a linear actuator. Preferably it includes a stepper motor. Preferably the actuator includes a leadscrew, suitably an integral leadscrew. This can provide a compact linear drive. Suitably the dispense blade actuator is located behind a coverslip in the start position, e.g. behind the cartridge retaining means.

In a related aspect the present invention provides a portable coverslip dispensing device having a dispense blade for dispensing coverslips.

Preferably the dispensing mechanism is adapted to move a coverslip from a start position in a cartridge to a dispensed position so that in the dispensed position the entire coverslip is outside the cartridge.

Suitably, where the dispensing mechanism includes a dispense blade, the dispense blade is moveable between a retracted position and an extended position (corresponding to the coverslip having been moved to the dispensed position). Preferably in the extended position the front of the dispense blade extends beyond the front of the coverslip when the coverslip is in the start position. Suitably it extends beyond the front of the cartridge (suitably beyond the front of the cartridge retaining means; preferably beyond the front of the coverslip stop means discussed below). This has the advantage that the coverslip is then moved completely clear of the cartridge so that there is no need for the user to pull the coverslip, they need only lift it from the device.

Preferably the coverslip dispensing mechanism dispenses only a single coverslip at a time from a stack of coverslips. Suitably the dispensing mechanism operates so that there is no movement (more preferably no movement in the dispensing direction, e.g. horizontal movement) of coverslips in the stack during dispensing of a coverslip except for the coverslip that is being dispensed. Suitably this can be achieved with the blade dispenser discussed above; the blade supports the stack of coverslips whilst dispensing the desired coverslip, so that the next coverslip does not “drop” until the blade has returned to a start position.

In relation to known portable coverslip dispensing devices the present inventors have noted that devices such as the ones described above having roller delivery mechanisms dispense a coverslip so that only part of the working surface of the coverslip is uncovered. As used herein, the term working surface means the surface which will be covered by a slide or glass sheet. The working surface is typically the upper face of the dispensed coverslip. In other words, the present inventors have noted that at least a part of the upper face of a coverslip dispensed by roller-based devices is obstructed or inaccessible when the coverslip is in a dispensed position on the device. This means that the coverslip must be removed from the device before the upper face is fully exposed. This makes it difficult or impossible to apply a glass slide to the coverslip whilst it is on the device.

Furthermore, known roller systems start dispensing a second coverslip before the first one has reached its dispensed position. This is because the rollers continue rotating even when the back edge of the coverslip has passed over them; the next coverslip in the stack drops down and the rollers impart a frictional force to that coverslip so that it immediately follows the preceding coverslip. This is another reason why it is not possible to reliably apply a glass slide to a coverslip when it is in the dispensed position, because of the possibility of contamination of the second partially dispensed coverslip.

To address these drawbacks, the present inventors propose that a coverslip dispensing device should be provided with a dispensing mechanism that transfers a coverslip into a dispensed position such that the working surface (typically the upper face) of the coverslip is unobstructed. Furthermore, that the dispensing mechanism should preferably dispense only one coverslip at a time.

Thus, preferably the coverslip dispensing mechanism moves a coverslip from a start position to a dispensed position; and the device includes a coverslip support structure that supports the coverslip in the dispensed position, wherein the entire upper surface of the coverslip is unobstructed when the coverslip is supported on the coverslip support structure in the dispensed position.

Suitably this arrangement means that a glass slide can be placed on top of the coverslip without having to move the coverslip from the dispensed position.

Thus, the coverslip support structure suitably does not overhang the upper surface of the coverslip. Preferably no part of the device overhangs the upper surface of the coverslip. Preferably no part of the device extends into the region directly above (i.e. substantially vertically above) the coverslip support structure.

Suitably the device includes a base member and the coverslip support structure is fixed with respect to the base member.

A further advantage of this arrangement is that the user does not need to move the coverslip horizontally in order to get it out of the device. The present inventors have found that it is desirable to minimise the amount of horizontal movement so as to minimise damage to the underside of coated coverslips.

Preferably the coverslip support structure includes an upper support that is in contact with the lower surface of the coverslip in the dispensed position. Suitably no part of the coverslip support structure extends into the region directly above (i.e. substantially vertically above) the upper support.

Suitably the upper support is narrower than the width of the coverslip. Preferably the width of the upper support is less than 18 mm, more preferably less than about 14 mm, most preferably less than about 12 mm. This makes it easier for the user to pick the coverslip up from the support structure.

Pre-coated or dry film coverslips are useful because they can reduce the complexity of a coverslipping operation by avoiding the need to apply a mountant (adhesive) to the coverslip or slide. In particular, this can avoid the need to have to prepare and maintain a mountant solution.

Examples of the coating (dry film) include a solvent activatable adhesive. Preferred examples include oil based or water insoluble adhesives. Particularly preferred examples include acrylic copolymers, olefin based adhesives and cellulose adhesives.

Typically, pre-coated coverslips need to be activated by applying a solvent to the dry film, for example by using a solvent dispenser.

Whilst the present inventors recognise the advantages of pre-coated or dry film coverslips, they have unexpectedly found that the performance of the pre-coated coverslips can be improved by pre-activating the coating. This typically involves applying a small amount of solvent to the dry film. This has been found to improve the quality of the prepared sample, in particular to reduce the incidence of trapped bubbles in the adhesive and/or sample.

Preferably the coverslip dispensing device of the present invention includes a liquid delivery system adapted to deliver a pre-activating liquid to at least 50% of the coated surface of a pre-coated coverslip. Thus, preferably, at least 50% of the pre-coated side of the coverslip can be covered with pre-activating liquid.

Preferably the liquid delivery system delivers a pre-activating liquid to at least 75% of the coated surface of the coverslip, more preferably at least 90%, most preferably substantially all of the coated surface. In preferred embodiments pre-activating liquid is delivered to substantially all of the face of the coverslip to which the coating has been applied

Preferably the liquid delivery system includes a roller for applying the pre-activating liquid to the coverslip. Preferably the liquid delivery system includes a doctor roller system.

A pre-activating liquid can be any liquid that activates the coating on a pre-coated coverslip. Examples of a pre-activating liquid include organic solvents such as aromatic and aliphatic hydrocarbons (e.g. alkyl esters, benzyl benzoates and xylene), silicones (e.g. dimethicones), and water based solvents.

In a related aspect the present invention provides a method of dispensing a coated coverslip, wherein the method includes the step of pre-activating the coating by applying a pre-activating liquid to at least 50% of the coating. Preferably the pre-activating liquid is applied to at least 75% of the coating, more preferably at least 90% and most preferably substantially all of the coating. Suitably pre-activating liquid is applied to at lest 50%, preferably at least 75%, more preferably at least 90%, and most preferably substantially all of the pre-coated side of the coverslip.

Preferably the method includes applying the pre-activating liquid with a roller, more preferably with a doctor roller system.

Preferably the step of dispensing the pre-coated coverslip includes dispensing it with the coating facing upwards. Alternatively the coverslip can be dispensed with the coating facing downwards.

Preferably the method includes contacting the pre-activated coverslip with a mountant, for example the mountant is on a slide and the coverslip and slide are brought together (e.g. with the coverslip remaining on the coverslip support structure). In embodiments, the method includes applying a solvent to the preactivated coverslip coating.

In a further related aspect, the present invention provides a coverslip dispensing device including a doctor roller system.

The present inventors have observed that known coverslip devices can sometimes dispense more than one coverslip at a time, due to adjacent coverslips sticking together.

In order to address this drawback and to accommodate coverslips of different thicknesses, preferably the coverslip dispensing mechanism of the device of the present invention is adapted to transfer a coverslip from a stack of coverslips to a dispensed position; and the device includes a coverslip stop means that prevents displacement of more than one coverslip at a time, wherein the coverslip stop means is adjustable so as to allow coverslips of different thicknesses to be transferred to the dispensed position.

Suitably the coverslip stop means prevents displacement of coverslips other than the bottommost coverslip in a stack (e.g. a stack located in a cartridge).

Typically the coverslip stop means is located in front of the cartridge (in a dispensing direction). Suitably the coverslip stop means is associated with the cartridge retaining means discussed above. Suitably the coverslip stop means includes an adjustable member that defines an opening through which a coverslip can be transferred. Typically the opening is defined by the adjustable member and another part of the device, for example the base of the device and/or the cartridge. Suitably the adjustable member can be moved with respect to the cartridge and/or the base of the device. Preferably the stop means is adjustable so as to change the size of the opening. Preferably the adjustable member can be moved in a substantially vertical direction to accommodate different coverslip thicknesses.

Preferably the adjustable member includes adjustment screws for fixing the member to the rest of the device at a desired position (i.e. to define the desired opening size).

In a further aspect the present invention provides a portable coverslip dispensing device for dispensing a coverslip having top and bottom faces and circumferential faces connecting the top and bottom faces, the device having a dispensing mechanism for transferring a coverslip from a start position to a dispensed position, wherein the dispensing mechanism contacts only a circumferential face of the coverslip during dispensing of the coverslip.

Optional and preferred features of this aspect are the same as discussed above with respect to the first aspect. In particular, “portable” preferably means that the device is battery operated.

In a further aspect the present invention provides a portable coverslip dispensing device having a coverslip dispensing mechanism for moving a coverslip from a start position to a dispensed position; and a coverslip support structure that supports the coverslip in the dispensed position, wherein the entire upper surface of the coverslip is unobstructed when the coverslip is in the dispensed position.

The optional and preferred features of this aspect are the same as the first aspect. In particular, “portable” means that the device is battery operated.

In a further aspect the present invention provides a coverslip dispensing device having a coverslip dispensing mechanism for dispensing coated coverslips and a liquid delivery system for delivering a pre-activating liquid to at least 50% of the coated surface of a coverslip.

The optional and preferred features of this aspect are the same as the first aspect. In particular, the device is preferably battery operated.

In a further aspect the present invention provides a coverslip dispensing device having a coverslip dispensing mechanism adapted to transfer a coverslip from a stack of coverslips to a dispensed position; and a coverslip stop means that prevents displacement of more than one coverslip at a time, wherein the coverslip stop means is adjustable so as to allow coverslips of different thicknesses to be transferred to the dispense position.

The optional and preferred features of this aspect are the same as those of the first aspect.

Each of the aspects previously described may be combined with one, more than one or all of the other aspects and features within each of the aspects may be combined with features from the other aspects. Therefore, in a further aspect, the present invention provides a coverslip dispensing device including one, more than one or all of the previous aspects.

### BRIEF DESCRIPTION OF THE DRAWINGS

The invention will now be described by way of example only with reference to the accompanying figures in which:

FIG. 1 shows a cross section of a coverslip dispensing device, being a first embodiment of the present invention;

FIG. 2 shows a perspective view of a coverslip dispensing device, being a second embodiment of the present invention; and

FIG. 3 shows a doctor roller system for delivering pre-activating fluid to a coverslip, being a further embodiment of the present invention.

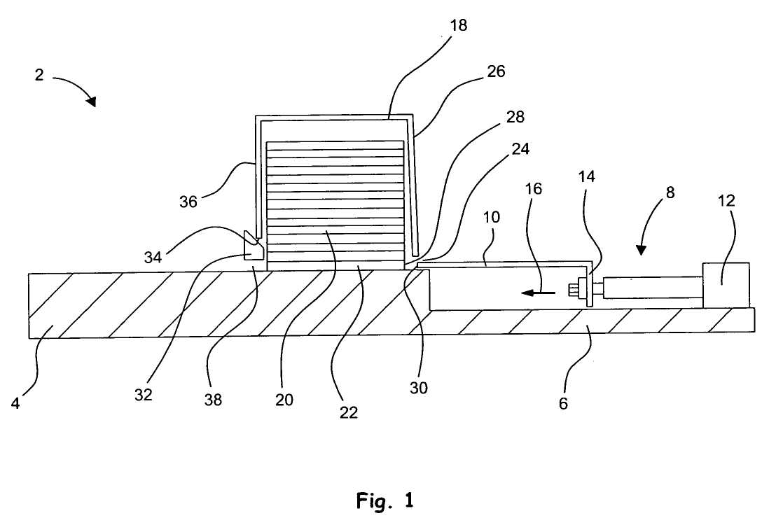

FIG. 1 shows a coverslip dispensing device 2 that has a base plate 4, which includes a rear portion 6 that has a reduced thickness compared to the rest of the base plate. Fixed to the rear portion is dispense mechanism 8 that includes dispense blade 10 and linear actuator 12.

The dispense blade 10 is connected to the linear actuator with a right-angled flange 14. The linear actuator imparts a horizontal displacement to the blade in the direction of arrow 16.

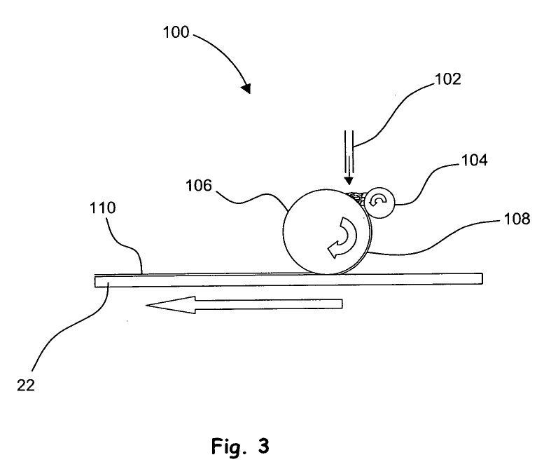

In use, a cartridge 18 containing a stack of coverslips 20 is positioned on the device 2 such that the lowermost coverslip 22 lies just above the base plate 4 (in fact, the coverslip 22 rests on coverslip support members formed at the bottom of the cartridge, for example as shown in FIG. 3).

The lowermost coverslip 22 is aligned with the dispense blade 10 and the cartridge 18 includes an opening 24 in its rear wall 26 so that the dispense blade can be moved against the rear circumferential face 28 of the coverslip 22. The horizontal motion of the dispense blade causes the blade end 30 to act on the rear circumferential face 28 thereby moving the coverslip 22 horizontally towards the front of the device in the direction of arrow 16.

The coverslip slides on top of the cartridge's coverslip support members (not shown) and moves with respect to the coverslips above it in the stack 20. The motive force provided by the dispense blade overcomes the friction between neighbouring coverslips and between the coverslip and the cartridge. Furthermore, stop member 32 is positioned in an opening 34 in the front wall 36 of the cartridge so as to define an dispenser opening 38. The size of this opening 38 is such the coverslips above the desired coverslip 22 are prevented from leaving the cartridge.

The stop member 32 is adjustable so as to change the size of the dispenser opening 38. For example, a larger opening would be needed for thicker coverslips.

When the dispense blade 10 is fully extended (i.e. when the coverslip has been dispensed), the blade end 30 is located in a position forward of the stop member 32. This means that the dispensed coverslip is entirely outside of the cartridge and stop member and can be easily removed from the machine by the user without having to slide the coverslip.

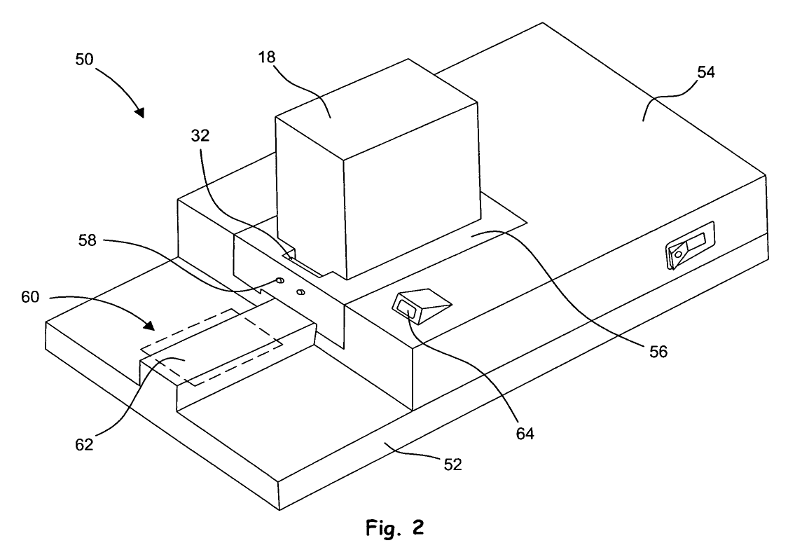

FIG. 2 shows a further example of a coverslip dispensing device according to the present invention. This device has the same dispense blade arrangement as the device shown in FIG. 1.

The device 50 has a base plate 52 to which is connected a dispense blade enclosure 54. A cartridge 18 containing a stack of coverslips is identical to the one described in FIG. 1. Located between the cartridge 18 and enclosure 54 is cartridge retainer 56. This helps to keep contaminants away from the coverslips and prevents the ingress of dust and dirt that could damage the dispensing mechanism. The cartridge retainer also serves to fix the cartridge in the desired position by providing an opening just large enough to receive the cartridge.

Attached to the retainer 56 is a stop member 32 that is identical to the one discussed with respect to FIG. 1. The stop member is attached to the retainer with a pair of screws 58. When the screws are loosened the stop member 20 can be moved up and down (e.g. parallel to the front wall 36 of the cartridge 18) so as to adjust the height of the dispenser opening 38 (not shown).

As discussed with respect to FIG. 1, when a coverslip has been transferred to the dispensed position 60 it lies entirely outside the cartridge, but also outside the retainer 56. This means that the dispensed coverslip 22 can be lifted from the device without any horizontal motion. This reduces the likelihood of damage to the coverslip, e.g. from scratches on the underside. Furthermore, it means that the entire upper surface of the coverslip is unobstructed so that a glass slide can be applied to the coverslip without having to move the coverslip.

In the dispensed position 60 the coverslip rests on support structure 62. In this embodiment the support structure comprises a block that extends upwards from the base plate 52. The block has a rectangular cross section although other shapes are possible. The shape of the support structure is such that the coverslip 22 is adequately supported and the coverslip overhangs the block along the entire length of the coverslip. The width of the block is about 15 mm, although other widths are possible.

The support structure 62 does not include any elements that cover or overhang the top surface of the coverslip. This means that it is possible to apply a slide or glass sheet directly on top of the coverslip without removing the coverslip from the dispensed position 60.

The device 50 includes an optical sensor 64. The optical sensor detects proximity, for example the proximity of a user's hand. The optical sensor is associated with a switch that operates the dispensing mechanism 8 in response to a signal from the optical sensor. When that signal has been received, the dispensing mechanism 8 moves the blade 10 through one cycle, i.e. the blade is moved from a start position (as shown in FIG. 1) to an extended position (at which point a coverslip has been moved to the dispensed position 60) and back to the start position. The dispense mechanism then stops. In order to dispense another coverslip the user must activate the optical sensor again.

The device 50 also includes an on/off power switch. The device is battery operated, although mains operation is possible in other embodiments.

FIG. 3 illustrates a doctor roller system for use in accordance with an aspect of the present invention. The doctor roller system 100 can be used with a device such as the ones illustrated in FIGS. 1 and 2, or with other devices, for example fully automated coverslippers. The doctor roller system is located in front of the stack of cartridges (in the dispensing direction) and applies a thin film of pre-activating liquid to a coated coverslip 22 as it moves from the stack to the dispensed position. In this embodiment the coverslip is coated on its upper face. The pre-activating liquid in this example is xylene, but other liquids can be used. The xylene is delivered from a reservoir at a controlled rate via tube 102 to a pair of contra-rotating rollers 104, 106. The rollers are arranged so that a thin layer of xylene 108 is applied to the larger application roller 106, which in turn deposits the xylene as a thin layer 110 on to the moving coverslip 22. In this way, the entire coated surface of the coverslip is covered with xylene. This pre-activation of the coated coverslip leads to reduced incidence of trapped air bubbles in the final assembled sample preparation.

The separation and/or tension between the two rollers 104, 106 can be adjusted so as to control the film 108 thickness on the application roller 106. The thickness of the film 110 applied to the coverslip can also be controlled by adjusting the position and/or tension of the application roller. The coverslip can be supported underneath by a further roller. In embodiments that employ a dispense blade to deliver the coverslip, the coverslip can be brought into the roller nip by the action of the blade.

These preferred embodiments have been described by way of example and it will be apparent to those skilled in the art that many alterations can be made that are still within the scope of the invention.

1. A coverslip dispensing device having a non-contact sensor associated with a coverslip dispensing mechanism wherein activation of the sensor causes operation of the dispensing mechanism.

2. A coverslip dispensing device according to claim 1, wherein the non-contact sensor is located on the exterior of the device.

3. A coverslip dispensing device according to claim 1, wherein the non-contact sensor faces towards the front of the device in the coverslip dispensing direction.

4. A coverslip dispensing device according to claim 1, wherein the non-contact sensor is an optical sensor.

5. A coverslip dispensing device according to claim 1, wherein the non-contact sensor is a capacitative sensor.

6. A coverslip dispensing device according to claim 1, wherein the non-contact sensor detects at least one of motion and proximity.

7. A coverslip dispensing device according to claim 1, wherein the device is battery operated.

8. A coverslip dispensing device according to claim 7, wherein the device includes means for connecting a battery to the device.

9. A coverslip dispensing device according to claim 1, wherein the device is portable.

10. A coverslip dispensing device according to claim 9, wherein the largest dimension of the device is less than 30 cm.

11. A coverslip dispensing device according to claim 9, wherein the device weighs no more than 4 kg.

12. A coverslip dispensing device according to claim 1, wherein the device includes coverslip cartridge retaining means for locating a coverslip cartridge with respect to the device during use.

13. A coverslip dispensing device according to claim 12, wherein the cartridge retaining means includes cartridge fixing means for fixing the cartridge to the device.

14. A coverslip dispensing device according to claim 13, wherein the cartridge fixing means includes a resilient member.

15. A device according to claim 12, wherein the device includes a cartridge for holding coverslips.

16. A device according to claim 1, wherein the device includes a liquid delivery system for delivering a pre-activating liquid to at least 50% of the coated surface of a pre-coated coverslip.

17. A device according to claim 16, wherein the liquid delivery system delivers a pre-activating liquid to at least 75% of the coated surface of the coverslip

18. A device according to claim 17, wherein the liquid delivery system delivers a pre-activating liquid to substantially all of the surface of the coverslip to which the coating has been applied.

19. A device according to claim 16, wherein the liquid delivery system includes a roller for applying the pre-activating liquid to the coverslip.

20. A device according to claim 19, wherein the liquid delivery system includes a doctor roller system.

21. A coverslip dispensing device according to claim 1, wherein the dispensing mechanism transfers a coverslip from a start position to a dispensed position, the coverslip having top and bottom faces and circumferential faces connecting the top and bottom faces, wherein the dispensing mechanism contacts only a circumferential face of the coverslip during dispensing of the coverslip.

22. A device according to claim 1, wherein the coverslip dispensing mechanism is adapted to move a coverslip from a start position to a dispensed position; and the device includes a coverslip support structure that supports the coverslip in the dispensed position, wherein the entire upper surface of the coverslip is unobstructed when the coverslip is supported on the coverslip support structure in the dispensed position.

23. A device according to claim 1, wherein the coverslip dispensing mechanism is adapted to transfer a coverslip from a stack of coverslips to a dispensed position; and the device includes a coverslip stop means that prevents displacement of more than one coverslip at a time, wherein the coverslip stop means is adjustable so as to allow coverslips of different thicknesses to be transferred to the dispensed position.

24. A device according to claim 1, wherein the dispensing mechanism is adapted to move a coverslip from a start position in a cartridge to a dispensed position so that in the dispensed position the entire coverslip is outside the cartridge.
